(19) United States
(12) Patent Application Publication
(10) Pub. No.: US 2011/0215134 A1
(43) Pub. Date: Sep. 8, 2011

(54) ROTARY DIE BONDING APPARATUS AND METHODOLOGY THEREOF

(76) Inventor: Ah Yoong SIM, Penang (MY)

(21) Appl. No.: 12/947,978

(22) Filed: Nov. 17, 2010

(30) Foreign Application Priority Data
Mar. 4, 2010 (MY) PI 2010000941

(51) Int. Cl. B23K 31/02; B23K 37/00

(52) U.S. Cl. 228/101; 228/47.1

(57) ABSTRACT

The present invention relates generally to a rotary die bonding apparatus (102) comprising a vertical motion linear actuator and a rotary motion actuator with a plurality of pick up heads (116) for transferring semiconductor die (122) from diced wafer to the lead frame for die bonding process, wherein said plurality of pick up heads (116) performs its assigned task such as pick (126), die bonding (132), inspection (128) and others simultaneously upon reaching its specific location and rotates to another location upon completion of each task to perform the next assigned task.

### 1. TECHNICAL FIELD OF THE INVENTION

The present invention relates generally to a rotary die bonding apparatus comprising a vertical motion linear actuator and a rotary motion actuator system with a plurality of pick up heads for transferring semiconductor die from diced wafer to the lead frame for die bonding process, wherein said plurality of pick up heads performs its assigned task such as pick, die bonding, inspection and others simultaneously upon reaching its specific location and rotates to another location upon completion of each task to perform the next assigned task.

### 2. BACKGROUND OF THE INVENTION

Generally, after a semiconductor die is being separated from the semiconductor wafer, or in other words, wafer dicing, said die will stay at the dicing tape until it is being handled or extracted by a die handling apparatus such as a die bonder or die sorter. Said die handling apparatus performs tasks such as die attach, whereby said die picked up from, the said wafer and performed the necessary tasks before mounted and fixed to a package or support structure. Other tasks that can be done using the said die handling apparatus is to handle the said die to be glued directly to the substrate such as printed wiring board using an epoxy adhesive. Epoxy resins are typically used to bond said die to circuit board substrates. This task is usually done for low cost and low powered applications. It can be appreciated that methods used to remove and deliver die from wafer have been in use for many years.

Conventionally, the die bonding apparatus has linear arm reciprocal pick and place method whereby a semiconductor device is capable of being pick up from a first predetermined position and deposited at a second predetermined position with linear movement and the reverse thereof in series.

More recently, swing arm reciprocal pick and place method is invented to continuously pick and place semiconductor device. This type of pick and place device comprises a swing arm that executes pick-up and placement motions in series. The drive mechanism comprises a rotating and swivelling member which can normally and reversely drive or rotate the said arm in an appointed range of rotation.

Among the limitations and deficiencies of the above inventions is the vibration on said apparatus during performance of each task. Current reciprocal design will increase vibration when speed increases, thus affecting the operation accuracy of the pick and place process. To overcome this problem, the weight of said apparatus can be increased but to a limited extend. Furthermore, by increasing of weight of said apparatus, more cost has to be incurred due to higher material usage.

In addition, the current reciprocal design will increase cycle time when any new process is added before, in between and after the task of transferring said die from the wafer to the printed circuit board. The operation has to be stopped before doing other tasks. As a result, throughput characteristics will be affected and this will cause low production yield.

It would hence be extremely advantageous if the above shortcoming is alleviated by having a rotary die bonding apparatus comprising a vertical motion linear actuator and a rotary motion actuator system with a plurality of pick up heads for transferring semiconductor die from diced wafer to the lead frame for die bonding process, wherein said plurality of pick up heads performs its assigned task such as pick, die bonding, inspection, die bonding, die coating and others simultaneously upon reaching its specific location and rotates to another location upon completion of each task to perform the next assigned task.

### 3. SUMMARY OF THE INVENTION

Accordingly, it is the primary aim of the present invention to provide a rotary die bonding apparatus for continuously transferring die from wafer to other forms of carrier.

It is yet another object of the present invention to provide a rotary die bonding apparatus which is able to perform die bonding.

It is yet another object of the present invention to provide a rotary die bonding apparatus with symmetrical design which generates low vibration.

It is yet another object of the present invention to provide a rotary die bonding apparatus with improved flexibility.

It is yet another object of the present invention to provide a rotary die bonding apparatus comprising a plurality of arms thereby allowing multiple tasks to be carried out at the same time.

It is yet another object of the present invention to provide a rotary die bonding apparatus functioned on indexing motion thereby improves the speed of pick and place.

It is yet another object of the present invention to provide a rotary die bonding apparatus with throughput improvement by complete pick and place activities simultaneously.

It is yet another object of the present invention to provide a rotary die bonding apparatus whereby the vertical motion actuator (104) has a direct drive mechanism, which does not need a cam and therefore makes the vertical motion operation easier, faster and more accurate.

Other and further objects of the invention will become apparent with an understanding of the following detailed description of the invention or upon employment of the invention in practice.

These and other objects are achieved by the present invention, which in its preferred embodiment provides,

A rotary semiconductor die bonding apparatus comprising:
a plurality of pick up heads;
characterized in that
further comprising of:
   a direct drive rotary motor indexer;
   a rotary dish;
   a vertical motion actuator to push or release the pick up heads to or from original or intended location mounted on the rotary dish in Z-axis;
   a vacuum converter to distribute the vacuum from main vacuum line to all pick-up heads without direct tubing;
said plurality of pick up heads is attached to the circumference of said rotary dish;
said plurality of pick up heads are arranged to be the same distance from the central point of said rotary dish.

### 4. BRIEF DESCRIPTION OF THE DRAWINGS

Other aspect of the present invention and their advantages will be discerned after studying the Detailed Description in conjunction with the accompanying drawings in which:

FIG. 1 shows a perspective view of the rotary die bonding apparatus together with the image capturing apparatus and epoxy syringe.

FIG. 2 shows a top view of the rotary die bonding apparatus.

FIG. 3 shows a side view of the pick up head module together with the vertical motion linear actuator.

### 5. DETAILED DESCRIPTION OF THE DRAWINGS

In the following detailed description, numerous specific details are set forth in order to provide a thorough understanding of the invention. However, it will be understood by those or ordinary skill in the art that the invention may be practiced without these specific details. In other instances, well known methods, procedures and/or components have not been described in detail so as not to obscure the invention.

The invention will be more clearly understood from the following description of the embodiments thereof, given by way of example only with reference to the accompanying drawings which are not drawn to scale.

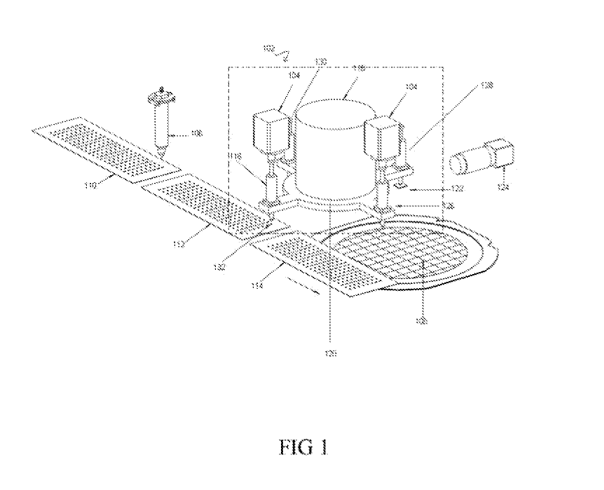

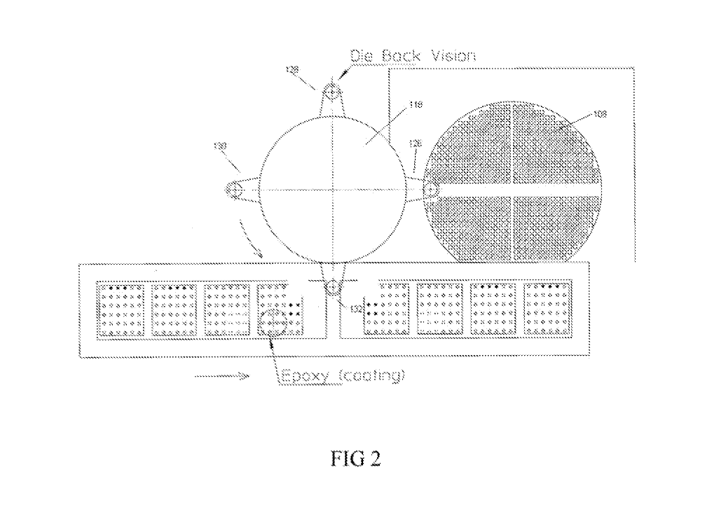

Referring to FIG. 1, there is shown a perspective view of the rotary die bonding apparatus (102) together with the image capturing apparatus (124), epoxy syringe (106), die wafer ring (108) and the lead frame (112, 114); further substantiated by FIG. 2, showing a top view of the rotary die bonding apparatus (102). The said rotary die bonding apparatus (102) comprises of a rotary dish (120), a plurality of pick up heads (116) on said rotary dish (120), a plurality of vertical motion actuator such as direct drive linear electric servo motor (104) attached to a plate with substantially flat bottom to actuate said pick up heads (116), and a direct drive rotary motor (118) wherein the said direct drive rotary motor (118) is used to continuously drive said rotary dish (120) in radial movement, with the required positional accuracy, force and speed. The said rotary dish (120) is also referred to as a rotary turret head.

The plurality of pick up heads (116) are placed at the circumference of said rotary dish (120) and the distance between each neighbouring pick up head (116) is constant throughout the whole circumference of the said rotary dish (120) in order to achieve the optimum stability of the said apparatus. Furthermore, said plurality of pick up heads (116) are arranged to be the same distance from the central point of said rotary dish (120). The said direct drive rotary motor (118) controls said plurality of pick up heads (116), through the said rotary dish (120), to stop momentarily at specific locations (126, 128, 132, 130). The said direct drive linear electric motors (104) are placed above and vertically aligned to said pick up heads (116) in order to actuate the said pick tip heads (116) to move vertically for pick ups and placing. The said pick up heads (116) are able to pick up small objects with flat surface such as a die (122). Said direct drive linear electric motors (104) are only placed at stations whereby picking and placing actions are required, such as die picking (126) and die bonding (132). While the pick up heads (116) are rotating for each task, the said direct drive linear electric motor (104) will remain stationary on the required pick and place stations. The said rotary semiconductor die bonding apparatus (102) further comprises at least one vacuum converter to distribute vacuum from the main vacuum line to all pick up heads (116) without direct tubing. The vacuum is supplied to the pick up heads so that a suction force is created to the said pick up head to pick up said die when said pick up head is in contact with said die. If pick up head needs to release said die, said vacuum converter is disabled to eliminate any vacuum to the said pick up head.

The number of pick up heads (116) on the said rotary dish (120) depends on the number of tasks that is needed for the application. The higher number of tasks needed to be performed by the said rotary die bonding apparatus (102), the higher number of pick up heads (116) is needed. The said pick up heads (116) are used to pick up the semiconductor die (122) in the die picking station (126), hold the said die (122) in other stations while performing certain tasks and release the said die at either the lead frame (112, 114).

The said rotary dish (120) has a symmetrical design which allows only low vibration to be generated. Furthermore, the indexing speed of the rotary die bonding apparatus (102) can be increased without increasing the vibration. Indexing speed refers to the time taken for a particular pick up head (116) from one station to the following station. The amount of station depends on the amount of pick up heads (116) on the said rotary dish (120). The stations can comprise of, but not limited to die picking station (126) either with or without flipper from the wafer ring (108), inverted vision inspection station (128) using a die back or die package vision inspection camera (124), die bonding station (132) and purging station (130). The continuous rotation of the rotary dish (120) comprising a plurality of pick up heads (116) allow a plurality of tasks to be performed simultaneously, thus improve the efficiency of the rotary die bonding apparatus (102).

An example of a complete cycle of the rotary die bonding apparatus (102) starts at the die picking station (126) and ends at the die bonding station (132). At the said die picking station (126), the direct drive linear electric motor (104) actuates the pick up head (116) will pick up at least a die (122) from a wafer ring (108) with the help of the suction force contributed by the vacuum converter, which said pick up head is then moved vertically upwards by having the said vertical motion actuator to retract or pull. The usage of the said pick up heads (116) depends on its application and need. After that, the rotary dish (120) will be turned by the direct drive rotary electric motor (118) to transfer said die (122) from the die picking station (126) to the inverted vision inspection station (128), whereby the die surface (122) will be inspected by the 2D/3D die surface vision inspection system preferably a die back vision inspection camera (124), vertically aligned or substantially perpendicularly aligned to said pick up head, for bond pad, hump or ball quality and cosmetic defect. The said rotary dish (120) will rotate again to the purging station (130), whereby rejected dies which are determined by the vision inspection system is being released to a certain bin for disposal or rework. At the die bonding station (132), said vertical motion actuator (104) pushes the pick up head to bond said die (122) to the lead frame (112, 114) that has already gone through an epoxy dispensing station of epoxy coating (110). After the die bonding step, said rotary semiconductor die bonding apparatus (102) deactivates the vacuum pressure to the said pick up head (116) to eliminate the vacuum pressure between said pick up head (116) and semiconductor die (122). After the vacuum pressure is eliminated, the die (122) is detached from the pick up head (116), which the vertical motion actuator (104) will be retracted to enable the pick up head (116) to move vertically up. Lastly, the direct drive rotary electric motor (118) rotates the rotary dish (120) again back to the die picking station (126) for another cycle of die bonding process. All the processes of die picking (126), die back inspection (128), die purging (130) and die bonding (132) are done simultaneously. After a process cycle is completed, it can be repeated.

The example shown above is for four stations (126, 128, 132, 130) in each cycle. The said semiconductor die bonding methodology and apparatus (102) is able to be modified whereby said stations can be added or decreased in order to suit the number of tasks needed to be done by said rotary semiconductor die bonding apparatus (102). Furthermore, the amount of pick up heads (116) needs correspond to the amount of tasks or stages for a single cycle.

Previous linear typed die bonding apparatus needs extra cycle time if additional tasks are needed to be performed by the same apparatus. The continuous picking and placing process is done simultaneously, thus improving the throughput of the pick and place process. Besides that, the cycle time will not increase when a new process is added. Other tasks such as die back vision can be performed by the said rotary die bonding apparatus (102) by adding pick up heads (116) to the said rotary dish (120) and adjusting the indexing angle.

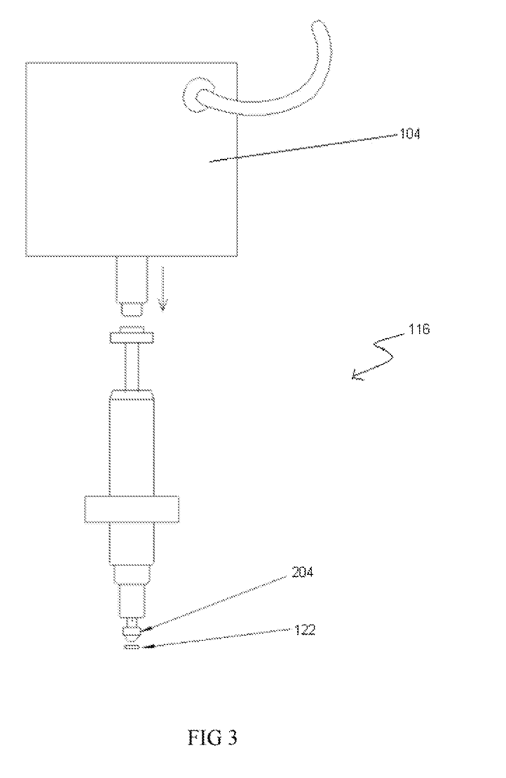

Referring to FIG. 3, there is shown a side view of the pick up head module (166) together with the direct drive linear electric motor (104). The said pick up head (116) is attached to the circumference of the rotary dish (120) to be rotated to perform different tasks while the direct drive linear electric motor (104) is stationary at a particular station whereby picking and placing action is required. The direct drive linear electric motor (104) is arranged so that it can actuate downwards to further actuate the pick up head to move downwards. When the said direct drive linear electric motor (104) retracts, the pick up head (116) will automatically move upwards. The said pick up head module (116) comprises of a suction cup (204) that enables the die (122) to be attached to the said pick up head (116) after a picking action is being done.

While the preferred embodiment of the present invention and their advantages have been disclosed in the above Detailed Description, the invention is not limited thereto but only by the spirit and scope of the appended claim.

1. A rotary semiconductor die bonding apparatus comprising:
a plurality of pick up heads;
further comprising:
a direct drive rotary motor indexer;
a rotary dish;
said plurality of pick up heads are attached to the circumference of said rotary dish;
said plurality of pick up heads are arranged to be the same distance from the central point of said rotary dish.

2. A rotary semiconductor die bonding apparatus as claimed in claim 1, further comprising at least one vacuum converter to distribute the vacuum from main vacuum line to all pick-up head without direct tubing.

3. A rotary semiconductor die bonding apparatus as claimed in claim 1, wherein said rotary dish controls said plurality of pick up heads to stop momentarily at specific locations, referred to as stations.

4. A rotary semiconductor die bonding apparatus as claimed in claim 3, wherein at least one vertical motion actuator is located at one of said stations and vertically aligned to said pick up head to push said pick up head to said semiconductor die to pick up said semiconductor die with activated vacuum converter.

5. A rotary semiconductor die bonding apparatus as claimed in claim 1, wherein said rotary semiconductor die bonding apparatus is able to perform die back or die package vision inspection.

6. A rotary semiconductor die bonding apparatus as claimed in claim 3, wherein at least one camera is located at one of said stations and vertically or substantially perpendicularly aligned to said pick up head to capture image of said semiconductor die for inspection.

7. A rotary semiconductor die bonding apparatus as claimed in claim 3, wherein at least one vertical motion actuator is located at one of said stations and vertically aligned to said pick up head to push said pick up head to place said semiconductor die to a specific location with deactivated vacuum converter.

8. A rotary semiconductor die bonding apparatus as claimed in claim 4, wherein said plurality of stations is used to further perform tasks such as die picking, inverted vision inspection, die bonding and die purging.

9. A rotary semiconductor die bonding apparatus as claimed in claim 1, wherein said pick up head is able to pick up small object with flat surface.

10. A rotary semiconductor die bonding apparatus as claimed in claim 4, wherein said vertical motion actuator is a direct drive actuator.

11. A rotary semiconductor die bonding apparatus as claimed in claim 4, wherein said vertical motion actuator is driven directly by a linear servo motor.

12. A rotary semiconductor die bonding apparatus as claimed in claim 4, wherein said vertical motion actuator is attached to a plate with substantially flat bottom to control up and down position of the pick up heads.

13. A methodology of semiconductor die bonding, comprising the following stages:
(i) in the first stage:
(i)(i) at the first station, the following steps are taken:
(i)(i)(i) vertical motion actuator at first station pushes said first pick up head to semiconductor die;
(i)(i)(ii) rotary semiconductor die bonding apparatus activates vacuum pressure to the first pick up head to apply vacuum pressure between said first pick up head and said semiconductor die;
(i)(i)(iii) vertical motion actuator at first station pulls said first pick up head to pick said semiconductor die;
(i)(ii) at the second station, the camera at second station captures image of semiconductor die picked up by the second pick up head previously at the first station, for inspection;
(i)(iii) at the third station, the third pick up head purges or releases rejected dies;
(i)(iv) at the fourth station, the following steps are taken:
(i)(iv)(i) vertical motion actuator at fourth station pushes the fourth pick up head to a specific location for die bonding;
(i)(iv)(ii) rotary semiconductor die bonding apparatus deactivates vacuum pressure to the fourth pick up head to eliminate vacuum pressure between said fourth pick up head and semiconductor die;
(i)(iv)(iii) vertical motion actuator at fourth station pulls said fourth pick up head;
(ii) in the second stage, the rotary dish at the rotary semiconductor die bonding apparatus rotates to transfer the following pick up heads to the following stations:
the first pick up head to the second station;
the second pick up head to the third station;
the third pick up head to the fourth station;
the fourth pick up head to the first station;
(iii) in the third stage, the rotary dish at the rotary semiconductor die bonding apparatus rotates to transfer the following pick up heads to the following stations:
the first pick up head to the third station;
the second pick up head to the fourth station;
the third pick up head to the first station;
the fourth pick up head to the second station;
(iv) in the fourth stage, the rotary dish at the rotary semiconductor die bonding apparatus rotates to transfer the following pick up heads to the following stations:
the first pick up head to the fourth station;
the second pick up head to the first station;
the third pick up head to the second station;
the fourth pick up head to the third station;
wherein all said stages is repeated.

14. A methodology of semiconductor die bonding as claimed in claim 13, wherein the amount of said stages is same as the amount of said pick up heads on said rotary dish.

15. A methodology of semiconductor die bonding as claimed in claim 13, wherein the amount of said stations is able to be added or decreased to suit the number of tasks needed to be done by said rotary semiconductor die bonding apparatus.

16. A methodology of semiconductor die bonding as claimed in claim 14, wherein the amount of said stations is able to be added or decreased to suit the number of tasks needed to be done by said rotary semiconductor die bonding apparatus.
